(19) United States
(12) Patent Application Publication
(10) Pub. No.: US 2016/0056891 A1
(43) Pub. Date: Feb. 25, 2016

(54) OPTICAL SIGNAL-TO-NOISE RATIO MEASURING METHOD

(71) Applicant: ACCELINK TECHNOLOGIES CO., LTD., Hubei (CN)

(72) Inventors: Shuang Chen, Wuhan (CN); Liping Sun, Wuhan (CN); Qianggao Hu, Wuhan (CN); Yan Chen, Wuhan (CN); Hui Xie, Wuhan (CN); Qingyan Yue, Wuhan (CN); Fei Liang, Wuhan (CN); Yin Zhang, Wuhan (CN); Hehui Wu, Wuhan (CN)

(73) Assignee: Accelink Technologies Co., Ltd., Wuhan (CN)

(21) Appl. No.: 14/780,378

(22) PCT Filed: Sep. 30, 2013
(86) PCT No.: PCT/CN2013/084670

§ 371 Date: Sep. 25, 2015

(30) Foreign Application Priority Data
Mar. 26, 2013 (CN) 201310098130.9

(51) Int. Cl. H04B 10/079; H04J 14/02; H04J 14/06

(52) U.S. Cl. CPC H04B 10/07953; H04J 14/06; H04J 14/0227

(57) ABSTRACT

An OSNR measuring method, comprising: measuring a spectrum to be measured of an optical signal at a point to be measured of an optical transmission line, and acquiring the comparative spectrum of the optical signal within a channel wavelength range and at an SNR different from the SNR of the point to be measured; respectively integrating, within the channel wavelength range of the optical signal, the spectrum to be measured and the comparative spectrum to obtain total power Pspectrum to be measured and Pcomparative spectrum, and acquiring a noise factor F and a signal scale factor A; calculating, according to the total power, the noise factor and the signal scale factor, the noise power Pspectrum to be measured within the channel wavelength range of the optical signal, so as to obtain an OSNR of the point to be measured.

### TECHNICAL FIELD

Embodiment of this invention involves OSNR measuring method, especially an in-band OSNR monitoring method of optical communication field, that is suitable for the on-line utilization in wavelength divided multiplexer (WDM) system.

### TECHNICAL BACKGROUND

Optical signal-to-noise ratio (OSNR) is directly related to bit error rate of optical signal transmission, and is a key performance indicator in optical communication network. Major source of optical noise of optical communication network is the Amplified Spontaneous Emission(ASE)of optical amplifier.

IEC 61280-2-9 standard disclosed a standard method to measure the OSNR of the Dense wavelength division multiplexing (DWDM). This method is to measure noise power of out-of-band signal, so as to estimate the noise in the channel by interpolation. The method fails in the following two cases. In the first case, the noises of out-of-band signal and the noise of in-band signal are different. For example, for Re-configurable Optical Add-Drop Multiplexer (ROADM), filtering effect may make the noise among channels and noise of in-band signal greatly different. In the second case, the spectrum of the signal per se and the spectrum of the noise of out-of-band signal are overlapped, for example, for the signal at the rate of 40 G/100 G, its signal spectrum bandwidth is relatively large, overlapped with out-of-band noise.

A common in-band OSNR measuring method is “turn-off” method, wherein by turning off the signal of the channel to be measured, the noise in The channel can be measured and in-band OSNR can be acquired. The method is obviously not suitable to be applied into on-line measurement. The existing on-line in-band OSNR measuring method is mainly based on difference of polarization property of signal part and noise part of the light in the channel, i.e., supposing the inherent channel noise is generally non-polarized, and the polarization of the signal light is very high, that is, the signal light is polarization-dependent. For example, the disclosed U.S patent “In-band optical signal to noise ratio determination method and system (Pub.No.: US 2010/0129074 A1)” related to a measuring method based on whether signal light is single polarized light or non-polarized light, which is not suitable for polarization-multiplexed signal. The U.S patent “In-band optical-to-noise ratio measurement (Pub.No.:US 2012/0106951 A1)” requires the signal itself to have the periodical power modulation, which is not suitable for measuring any kinds of signals. Therefore, the existing on-line in-band OSNR measuring method can not realize the fast and accurate measurement on any signals including polarization-multiplexed signal.

### SUMMARY OF INVENTION

To solve the above mentioned technology problems, embodiment of this invention provides an optical signal-to-noise ration measuring method, comprising the following steps:

measuring spectrum to be measured of measured optical signal at spot to be measured on optical transmission line, wherein the spectrum to be measured includes spectrum power density distribution of the measured optical signal in the channel wavelength range B;

obtaining spectrum to be compared, which includes spectrum power density distribution of the measured optical signal or signal with same spectrum feature as that of the measured optical signal, under SNR different from that of the spot to be measured in the channel wavelength range B;

in the channel wavelength range B, integrating the spectrum to be measured and the spectrum to be compared, respectively, to obtain total powers of the spectrum to be measured and the spectrum to be compared; and

according to integral power relationship and OSNR relationship between optical signal parts of the spectrum to be measured and the spectrum to be compared, using the obtained total powers of the spectrum to be measured and the spectrum to be compared, to estimate the OSNR at the spot to be measured.

Embodiment of this invention also provides in-band OSNR measuring method for measuring OSNR at the spot to be measured on the optical transmission line, including following steps:

step 1, measuring spectrum to be measured of measured optical signal at spot to be measured, wherein the spectrum to be measured includes spectrum power density distribution of the measured optical signal in the channel wavelength range B;

step 2, obtaining spectrum to be compared, which includes spectrum power density distribution of the measured optical signal or signal with same spectrum feature as that of the measured optical signal, under SNR different from that of the spot to be measured in the channel wavelength range B;

step 3, within the channel wavelength range B, integrating the spectrum to be measured and the spectrum to be compared respectively, to obtain the total powers of the spectrum to be measured and the spectrum to be compared respectively, wherein the total power P_{spectrum to be measured} of the spectrum to be measured includes integral power S_{spectrum to be measured} of optical signal and the integral power N_{spectrum to be measured} of noise signal, in the spectrum to be measured, and the total power P_{spectrum to be compared} of the spectrum to be compared includes the integral power S_{spectrum to be compared} of optical signal and the integral power N_{spectrum to be compared} of noise signal, in the spectrum to be compared;

Step 4, acquiring noise figure F and signal scale factor A, wherein the noise figure F is defined as:

$$F = \frac{{S}_{spectrum to be measured} / {N}_{spectrum to be measured}}{{S}_{spectrum to be compared} / {N}_{spectrum to be compared}} ,$$

wherein the signal scale factor A is defined as:

$$A = \frac{{S}_{spectrum to be compared}}{{S}_{spectrum to be measured}} ,$$

Step 5, according to the total powers P_{spectrum to be measured} and P_{spectrum to be compared} of the spectrum to be measured and the spectrum to be compared, as well as noise figure F and signal scale factor A, computing noise power N_{spectrum to be measured} of the spectrum to be measured in the channel wavelength range B, subtracting the noise power N_{spectrum to be measured} of the spectrum to be measured from the total power P_{spectrum to be measured} of the spectrum to be measured, then dividing by noise power

$${N}_{spectrum to be measured} \cdot \frac{{B}_{r}}{B}$$

in the integral bandwidth Bᵣ, to calculate OSNR of the measured optical signal at the spot to be measured.

According to the above mentioned technical solution, before getting the spectrums to be measured and the spectrum to be compared, no signal modulation including polarization modulation is conducted on the measured optical signal.

Embodiment of this invention also provides an in-band OSNR measuring device, comprising an input end, an optical amplifying module, a spectrum measuring module, and a control and computing module, wherein,

the optical amplifying module comprises an optical splitter and an optical amplifier;

the spectrum measuring module comprises a optical switch, and a spectrum scanner;

the input end input measured optical signal into the optical splitter, which splits the inputted measured optical signal into two branches, one of which is directly outputted to the optical switch in the spectrum measuring module, and the other is outputted into the optical switch in the spectrum measuring module via the optical amplifier, under control of the control and computing module, the optical switch selects one branch of optical signal from the two branches of optical signal, and output it to the spectrum scanner, under control of the control and computing modules, the spectrum scanner scans and measures the inputted optical signal.

Embodiment of this invention has realized the following technological effects.

By measuring the powers of the spectrum to be measured and the spectrum to be compared, fast estimation on the in-band OSNR is performed. It has no limitation on the transmission rate and code pattern of the signal to be measured, hence it can conduct the on-line measurement on signals of any rate, modulation format, single polarization or multiple polarization, without setting other auxiliary devices (such as polarization controller, and other signal modulation device) in the transmission system of the signal to be measured. The applied measuring device is of simple structure, and can realize the on-line fast measurement in a convenient manner. Besides, it also has very high accuracy and reliability compared to standard measurement result, and fits into the engineering application that does not have rigid accuracy requirement, is especially suitable to be realized in the Optical performance monitoring module (OPM) with the rate of 40 G or above.

### BRIEF DESCRIPTION OF THE APPENDED DRAWINGS

FIG. 1 is a principle block diagram for the OSNR measuring method of embodiment of the invention;

FIG. 2 is an exemplifying schematic diagram of comparing the spectrum to be measured and the spectrum to be compared;

FIG. 3 is a structural schematic diagram of the in-band OSNR measuring device of embodiment of the invention.

Numerals in the figures: 300-input end, 301-optical amplification module, 3011-optical splitter, 3012-optical amplifier, 302-spectrum measuring module, 3021-optical switch, 3022-spectrum scanner, 303-control and computing module.

### EMBODIMENTS

In order to facilitate the understanding and implementation of the invention hereof by average technicians, elaborate descriptions of embodiments of this invention are rendered hereinafter by utilizing both the attached drawings and the detailed embodiments.

OSNR measuring method in the invention is suitable for the on-line measurement on signals of any rate, modulation format, single polarization or multiple polarization, without additional signal modulation. Meanwhile, this measuring method has not any effect on the measured optical signal on the optical transmission path.

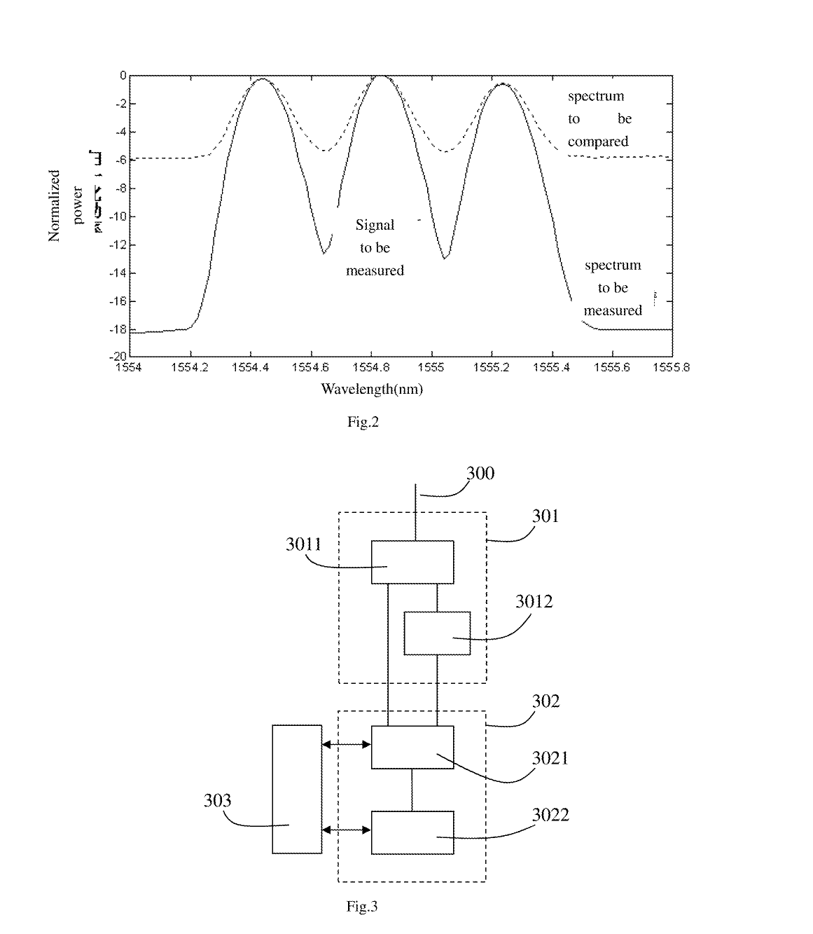

The measured optical signal in embodiment of the invention is indicated in FIG. 2, and is DWDM signal. In FIG. 2, the DWDM optical signal contains signals of 3 wavelengths with channel spacing of 50 GHz. As those skilled in the art will understand, the DWDM signals including signals of 3 wavelengths described herein are only exemplified to simply describe process of the embodiment. Actually, the DWDM optical signals applied in embodiments of the invention can contain signals of any number of wavelengths, e.g., signals of 2-160 or more wavelengths.

The main structure of the in-band OSNR measuring device provided in embodiment of the invention is illustrated in FIG. 3, comprising input end 300, optical amplification module 301, spectrum measuring module 302, control and computing module 303. The optical amplification module 301 consists of optical splitter 3011, optical amplifier 3012. The spectrum measuring module 302 consists of optical switch 3021, spectrum scanner 3022. The input end 300 is used to input the measured optical signal to the optical splitter 3011, which will split the input measured optical signal into two paths, one of the two paths is directly outputted to optical switch 3021 of spectrum measuring module 302, and the other of the two paths is amplified by the optical amplifier 3012 and outputted to optical switch 3021 of spectrum measuring module 302. Optical switch 3021 selects one of the two paths of the inputted optical signals under the control of control and computing module 303, to be outputted to spectrum scanner 3022. The spectrum scanner 3022 conducts scanning and measurement on the input optical signal, under the control of control and computing module 303. The optical splitter 3011 is a 1*2 optical splitter, the optical amplifier 3012 is erbium-doped optical fiber amplifier, and the optical switch 3021 is 2*1 optical switch based on Micro-Electro-Mechanical Systems(MEMS), the spectrum scanner 3022 makes scanning via Tunable optical filter based on MEMS technology. During the period that the measured optical signal enters from input end 300 and is inputted into the spectrum scanner 3022 for spectrum scanning, it does not undergo polarization modulation or any other signal modulation process.

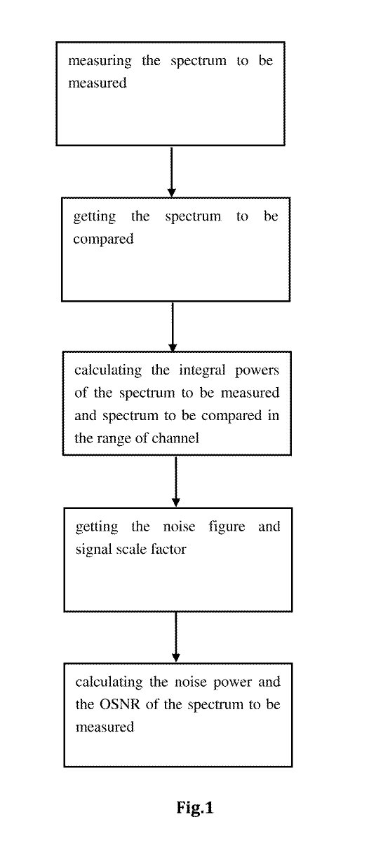

When measuring the OSNR, firstly, in-band OSNR measuring device is connected with the spot to be measured on the optical transmission line, as illustrated in FIG. 3. The OSNR measuring method is illustrated in FIG. 1, and the measurement process is as follows:

Step 1, measuring the spectrum to be measured, i.e, measuring the spectrum to be measured of the measured optical signal, at the spot to be measured on the optical transmission line, the step specifically comprising: controlling optical switch 3021 by the control and computing module 303, to directly input DWDM signal to be measured passing the optical splitter 3011 to the spectrum measuring module 302, and controlling the spectrum scanner 3022 to obtain the spectrum to be measured by scanning, wherein the spectrum includes the spectrum power density distribution of the measured optical signal in the range B of channel wavelength.

Step 2, obtaining spectrum to be compared, i.e, getting the spectrum to be compared of the measured optical signal or signal with same spectrum feature under OSNR different from that on the spot to be measured, the step specifically comprising: controlling optical switch 3021 by the control and computing module 303, to input DWDM signal to be measured passing the optical splitter 3011 to the spectrum measuring module 302 after amplified by the optical amplification module, and controlling the spectrum scanner 3022 to obtain the spectrum to be compareds. As shown in FIG. 2, optical signal amplified by the optical amplification module 301 and the measured optical signal directly inputted into spectrum scanner 3022 after going through the optical splitter 3011 have same peak wavelength, and can be regarded as of same spectrum feature.

Step 3, computing integral power of spectrum to be measured and the spectrum to be compared in channel range, i.e, obtaining total power P_{spectrum to be measured} and P_{spectrum to be compared} of the spectrum to be measured and the spectrum to be compared, that is, by integrating spectrum to be measured and the spectrum to be compared in channel wavelength range of the spectrum to be measured. The obtained total power includes the useful optical signal power and noise signal power of the spectrum to be measured and the spectrum to be compared, i.e, the integral power of signal part and noise part of 2 paths of measured optical signal inputted into spectrum measuring module 302 within the channel range.

The method to get the spectrum to be measured and the spectrum to be compared is to respectively integrate the spectrum to be measured and said spectrum to be compared within the channel range B.

$${P}_{spectrum to be measured} = {\int }_{B}^{ } {P}_{spectrum to be measured} ( λ ) d λ = {S}_{spectrum to be measured} + {N}_{spectrum to be measured}$$

$${P}_{spectrum to be compared} = {\int }_{B}^{ } {P}_{spectrum to be compared} ( λ ) d λ = {S}_{spectrum to be compared} + {N}_{spectrum to be compared}$$

wherein S_{spectrum to be measured} and S_{spectrum to be compared} are integral powers of optical signals of the spectrum to be measured and the spectrum to be compared respectively, N_{spectrum to be measured} and N_{spectrum to be compared} stand for the integral powers of spectrum to be measured and the spectrum to be compared within the channel range, respectively. P_{spectrum to be measured}(λ) stand for the power of the spectrum to be measured at the wavelength of λ; P_{spectrum to be compared}(λ) stand for the power of the spectrum to be compared at the wavelength of λ;

Step 4, obtaining the noise figure F and signal scale factor, specifically including:

defining the noise figure F as the ratio of OSNR of the spectrum to be measured and OSNR of the spectrum to be compared:

$$F = \frac{{S}_{spectrum to be measured} / {N}_{spectrum to be measured}}{{S}_{spectrum to be compared} / {N}_{spectrum to be compared}} ,$$

defining the signal scale factor A as the ratio of integral power of the optical signal part of the spectrum to be compared and the optical signal part of the spectrum to be measured:

$$A = \frac{{S}_{spectrum to be compared}}{{S}_{spectrum to be measured}}$$

Step 5, computing the noise power and OSNR of the spectrum to be measured, that is, according to the total powers P_{spectrum to be measured} and P_{spectrum to be compared} of the spectrum to be measured and the spectrum to be measured, as well as noise figure F and signal scale factor A, computing integral power N_{spectrum to be measured} of noise signal of optical signal of the spectrum to be measured in the channel wavelength range; pursuant to the defined OSNR equation, subtracting the noise power N_{spectrum to be measured} of the spectrums to be measured from the total power P_{spectrum to be measured} of the spectrum to be measured, and dividing it by noise power to be measured in noise integral bandwidth B_{r, N}_{spectrum to be measured}·Bᵣ/B, thus obtaining the OSNR.

By combing above equations, following equation set can be get:

$$\{ \begin{matrix}{S}_{spectrum to be measured} + {N}_{spectrum to be measured} = {P}_{spectrum to be measured} \\ A \cdot {S}_{spectrum to be measured} + F \cdot A \cdot {N}_{spectrum to be measured} = \\ {P}_{spectrum to be compared}\end{matrix}$$

By solving them, noise calculation equation of the spectrum to be measured can be obtained as follows:

$${N}_{spectrum to be measured} = \frac{1}{( 1 - F )} ( {P}_{spectrum to be measured} - \frac{{P}_{Spectrum to be compared}}{A} ) .$$

By substituting above noise calculation equation into the definition of OSNR, the OSNR of the measured optical signal can be calculated as follows:

$$OSNR = 10 {log}_{10} ( \frac{{P}_{spectrum to be measured} - {N}_{spectrum to be measured}}{{N}_{spectrum to be measured} \cdot \frac{{B}_{r}}{B}} ) ,$$

wherein Bᵣ is the integral bandwidth of noise signal, B is the channel bandwidth. According to the above calculation equations, if the noise figure F and signal scale factor A are known, OSNR can be calculated according to the total powers of the spectrum to be measured and the spectrum to be compared.

If the OSNR of the spectrum to be compared in the range of channel wavelength is known, according to the definition of noise figure F, that expresses F as the function that only includes the noise power N_{spectrum} to be measured within the range of the channel wavelength, i.e.,

$$F = ( {P}_{spectrum to be measured} - {N}_{spectrum to be measured} ) / ( {N}_{spectrum to be measured} \cdot {OSNR}_{spectrum to be compared} ) ,$$

wherein OSNR_{spectrum to be compared} is the OSNR of the spectrums to be compared. _{By substituting it into the noise calculation equation, the result can be get as follows:}

$${N}_{spectrum to be measured} = \frac{1}{\begin{matrix}( 1 - ( {P}_{spectrum to be measured} - {N}_{spectrum to be measured} ) / \\ ( {N}_{spectrum to be measured} \cdot {OSNR}_{spectrum to be compared} ) )\end{matrix}} ( {P}_{spectrum to be measured} - \frac{{P}_{spectrum to be compared}}{A} )$$

Through calculating and solving the equations, the noise power N_{spectrum to be measured} of the spectrum to be measured can be acquired.

When in the other optical transmission lines, the other high-cost method(such as turn-off method) to measure the signals of the same spectrum feature as the signals to be measured (such as the signals of the same rate and modulation format as the signals to be measured), acquire the OSNR of a certain spot to be measured, and use the mixed spectrum of the signal to be measured and noise at the spot to be measured as spectrum to be compared; or, when at the other spot to be measureds on the line of optical transmission of the signal to be measured, other measuring methods is adopted to get the OSNR of the spot to be measured and use the spectrum of the spot as spectrum to be compared, it is suitable to adopt above method to obtain the noise power of the spectrum to be measured.

If the OSNR of the spectrum to be compared in the range B of channel wavelength is unknown and the OSNR of the spectrum to be compared is greatly larger than that of the spectrum to be measured (for example, in the optical transmission line of the signal to be measured, for measuring the spectrum of the signal to be measured or the other signal with the same spectrum feature at the signal originating terminal or the spot to be measured much closer to the originating terminal than the spot to be measured, the noise is much less than the noise of the spectrum to be measured, and OSNR is much greater than the OSNR of the spectrum to be measured; or, for measuring the spectrum with same spectrum feature as that of the signal to be measured at the signal originating terminal on other optical signal transmission line and using it as spectrum to be compared, its OSNR is far greater than the OSNR of the spectrum to be measured), hence the noise figure F is much less than 1, approaching 0. In the noise figure calculation equation, noise figure F is set to 0, and calculate the integral power of the noise signal:

$${N}_{spectrum to be measured} = {P}_{spectrum to be measured} - \frac{{P}_{spectrum to be compared}}{A} .$$

Or, if the OSNR of the spectrum to be compared in the range of channel wavelength is unknown and the OSNR of the spectrum to be compared is greatly smaller than that of the spectrum to be measured (for example, for measuring the spectrum of the signal to be measured or the other signal with the same spectrum feature at the signal originating terminal or the spot to be measured much closer to the originating terminal than the spot to be measured, the noise is much greater than the noise of the spectrum to be measured, and OSNR is much greater than the OSNR of the spectrum to be measured. Or, by introducing the signal at the spot to be measured and going through light path with OSNR degradation, the spectrum of the signal to measured is measured and used as spectrum to be compared. Or, the spectrum of the same spectrum feature as that of the signal to be measured at the spot to be measured of other light signal transmission path with much smaller OSNR than that of the spot to be measured is measured as spectrum to be compared), hence noise figure F can be estimated through the following method:

taking the example of acquiring the OSNR of the second signal to be measured as in FIG. 2, noise figure F and scale factor A thereof can be calculated. In the channel wavelength range, by choosing the range of signal peak wavelength of 20 pm as the first integral bandwidth BW1, the integral of the spectrums to be measured and the spectrum to be compared at the first integral bandwidth BW1 can be calculated to get integral powers

$${P}_{BW 1}^{spectrum to be measured} {P}_{BW 1}^{spectrum to be compared} .$$

By choosing the range of 20 pm of signal peak index shifting 60 pm to shortwave as the second integral bandwidth BW2, the integral of the spectrum to be measured and the spectrum to be compared at the second integral bandwidth BW2 can be calculated respectively to get the integral powers

$${p}_{BW 2}^{spectrum to be measured} {p}_{BW 2}^{spectrum to be compared} .$$

The first scale factor can be calculated as:

$$k 1 = {P}_{BW 1}^{spectrum to be measured} / {P}_{BW 1}^{spectrum to be measured} ,$$

and the second scale factor can be calculated as:

$$k 2 = {P}_{BW 1}^{spectrum to be compared} / {P}_{BW 2}^{spectrum to be compared} ;$$

getting estimated value

$${N}_{BW 1}^{spectrum to be compared}$$

of integral power of noise signal of the spectrum to be compared in the first integral bandwidth BW1 and calculating the third scale factor as

$$k 3 = ( {p}_{BW 1}^{spectrum to be compared} - {N}_{BW 1}^{spectrum to be compared} ) / {N}_{BW 1}^{spectrum to be compared} ;$$

calculating the noise figure by using the equation as follows:

F=k2·(BW1−BW2˜k1)/(BW·k1−BW2·k1·k2+BW1·k1·k3−BW1·k2·k3)

wherein, he above equation can be acquired through the following method:

approximately, regarding the average noise power density distribution at the first integral bandwidth and that of the second integral bandwidth are approximately equal, i.e.,

$$\frac{{N}_{BW 1}^{spectrum to be compared}}{{N}_{BW 2}^{spectrum to be compared}} = \frac{{N}_{BW 1}^{spectrum to be measured}}{{N}_{BW 2}^{spectrum to be measured}} = \frac{BW 1}{BW 2} ,$$

substituting the above equation into the definition on the first scale factor:

$$\begin{matrix}k 1 = \frac{{P}_{BW 1}^{spectrum to be measured}}{{P}_{BW 2}^{spectrum to be measured}} \\ = \frac{{S}_{BW 1}^{spectrum to be measured} + {N}_{BW 1}^{spectrum to be measured}}{{S}_{BW 2}^{spectrum to be measured} + {N}_{BW 2}^{spectrum to be measured}} \\ = \frac{\frac{{S}_{BW 1}^{spectrum to be measured}}{{N}_{BW 1}^{spectrum to be measured}} \cdot BW 1 + BW 1}{\frac{{S}_{BW 2}^{spectrum to be measured}}{{N}_{BW 2}^{spectrum to be measured}} \cdot BW 2 + BW 2} ,\end{matrix}$$

then, according the definition on noise figure

$$F = \frac{{S}_{BW 1}^{spectrum to be measured} / {N}_{BW 1}^{spectrum to be measured}}{{S}_{BW 1}^{spectrum to be compared} / {N}_{BW 1}^{spectrum to be compared}} = \frac{{S}_{BW 2}^{spectrum to be measured} / {N}_{BW 2}^{spectrum to be measured}}{{S}_{BW 2}^{spectrum to be compared} / {N}_{BW 2}^{spectrum to be compared}} ,$$

the first scale factor can be expressed as:

$$k 1 = \frac{k 3 \cdot F \cdot BW 1 + BW 1}{k 4 \cdot F \cdot BW 2 + BW 2}$$

wherein

$$k 3 = {S}_{BW 1}^{spectrum to be compared} / {N}_{BW 1}^{spectrum to be compared} , \\ K 4 = {S}_{BW 2}^{spectrum to be compared} / {N}_{BW 2}^{spectrum to be compared} ;$$

In the same way, the second scale factor can be expressed as:

$$k 2 = \frac{k 3 \cdot BW 1 + BW 1}{k 4 \cdot BW 2 + BW 2} .$$

By combing equations for the first and second scale factors and canceling k4, the noise figure equations on k1, k2, k3 can be obtained:

F=k2·(BW1−BW2·k1)/(BW1·k1−BW2·k1·k2+BW1·k1·k3−BW1·k2·k3)

The estimated value N_{BW1}^{spectrum to be compared} of noise power in the first integral bandwidth BW1 of the spectrum to be compared and signal scale factor A can be obtained in the following method.

The third integral bandwidth BW3 in the channel wavelength range B of the spectrum to be compared is chosen, wherein signal takes relatively larger proportion than noise. For example, the third integral bandwidth as in FIG. 2 can be chosen to have same bandwidth as that of the first integral bandwidth. By choosing the third integral bandwidth BW3 within the range of 20 pm from the signal peak wavelength, the noise powers of the spectrum to be measured and the spectrum to be compared within the third integral bandwidth BW3 are estimated to be very small, assuming both to be 0, thus obtaining scale factor

$$A = {P}_{BW 3}^{spectrum to be compared} / {P}_{BW 3}^{spectrum to be measured} .$$

The fourth integral bandwidth BW4 in the channel wavelength range B of the spectrum to be compared is chosen, wherein signal takes relatively smaller proportion than noise. For example, the bandwidth of the fourth integral BW4 can be chosen to have the range of 20 pm from signal peak wavelength shifting 60 pm to long wave or shortwave as shown in FIG. 2. Based on the signal scale factor A, the noise power within the fourth integral bandwidth BW4 of the spectrum to be compared can be calculated, that is,

$${N}_{BW 4}^{spectrum to be compared} = {P}_{BW 4}^{spectrum to be compared} - A \cdot {P}_{BW 4}^{spectrum to be measured} .$$

Based on the noise power within the fourth integral bandwidth BW4, the noise power within the third integral bandwidth BW3 can be estimated.

$${N}_{BW 3}^{spectrum to be compared} = {N}_{BW 4}^{spectrum to be compared} \cdot BW 3 / BW 4$$

According to N_{BW3}^{spectrum to be compared}, the signal scale factor A is reestimated:

$$A = ( {P}_{BW 3}^{spectrum to be compared} - {N}_{BW 3}^{spectrum to be compared} ) / ( {P}_{BW 3}^{spectrum to be measured} - {P}_{BW 3}^{spectrum to be measured} ) .$$

Through iterative computations, convergent noise power N_{BW4}^{spectrum to be compared} of the spectrum to be compared in the fourth integral bandwidth BW4 can be calculated, and the iterative computation equation is as follows:

$${N}_{BW 4}^{spectrum to be compared} ( the {i}^{th} iteration ) = {P}_{BW 4}^{spectrum to be compared} - A ( the {i}^{th} iteration ) \cdot {p}_{BW 2}^{spectrum to be measured}$$

$$A ( the {i}^{th} iteration ) = ( {P}_{BW 3}^{spectrum to be compared} - {N}_{BW 4}^{spectrum to be compared} ( the {( i \text{-} 1 )}^{th} iteration ) \cdot \frac{BW 3}{BW 4} ) / ( {P}_{BW 3}^{spectrum to be measured} )$$

The estimated noise power value of the spectrum to be compared in the first integral band is:

$${N}_{BW 1}^{spectrum to be compared} = {N}_{BW 4}^{spectrum to be compared} \cdot BW 1 / BW 4.$$

According to N_{BW1}^{spectrum to be compared}, the third scale factor can be calculated as:

$$k 3 = ( {P}_{BW 1}^{spectrum to be compared} - {N}_{BW 1}^{spectrum to be compared} ) / {N}_{BW 1}^{spectrum to be compared} .$$

The noise figure F can be calculated as:

F=k2*(1−k1)/(k1−k1*k2+k1*k3−k2*k3)

In above equation, it is considered that BW1=BW2. The noise figure F and signal scale factor A are substituted into the noise calculation equation,

$${N}_{spectrum to be measured} = \frac{1}{( 1 - F )} ( {P}_{spectrum to be meassured} - \frac{{P}_{Spectrum to be compared}}{A} ) .$$

Through the above noise calculation equation, OSNR can be calculated as

$$OSNR = 10 {log}_{10} ( \frac{{P}_{spectrum to be measured} - {N}_{spectrum to be measured}}{{N}_{spectrum to be measured} \cdot \frac{{B}_{r}}{B}} ) ,$$

wherein Bᵣ is set at 0.1 nm, through calculation, the OSNR of the second signal to be measured in FIG. 2 is 22.3 dB. By adopting the standard measuring method, the actual OSNR is 21.7 dB with the error of 0.5 dB.

Or, the estimated value of power noise of spectrum to be compared N_{BW1}^{spectrum to be compared} in the first integral bandwidth BW1 and signal scale factor A can be acquired by the following method.

The corresponding optical signal of the spectrums to be measured can be taken as the input into the optical signal corresponding to the spectrums to be compared. The optical signal corresponding to the spectrums to be measured can be turned off, and added noise part of the spectrums to be compared in the first integral bandwidth BW1 can be regained. The added noise part can approximately substitute the estimated noise power value N_{BW1}^{spectrum to be compared} of the spectrums to be compared in the first integral bandwidth. _{The added noise part can be subtracted from the integral power of the spectrum to be compared within the channel wavelength range, and divided by the integral power of the spectrum to be measured in the channel wavelength range, to get the scale factor A of signal parts of the spectrums to be compared and the spectrum to be measured.}

As said in the above mentioned specific embodiment, according to the OSNR measuring method in embodiments of this invention, through analyzing the waveform features of signal in the optical transmission line to be measured, the manners for selecting the first integral bandwidth BW1, the second integral bandwidth BW2, the third integral bandwidth BW3 and the fourth integral bandwidth BW4 can be determined. Therefore, the above mentioned first to _{fourth integral bandwidths can also be selected within appropriate range other than those disclosed particular number values, which are still within the range of this invention.}

In the OSNR measuring method, by measuring spectrum of the optical signal with same spectrum feature as the optical signal at the spot to be measured, it can be used as the spectrums to be compared. However, actually, the spectrum to be compared can also be acquired through other methods:

The spectrum to be compared can be acquired by measuring the optical power density distribution within channel wavelength range of the optical signal, at other spot to be measureds with different OSNR from that of the spot to be measured in the optical transmission line.

Or, by introducing the optical signal at the spot to be measured to other spot to be measured via other transmission line, the spectrum to be compared can be acquired by measuring the optical power density distribution within channel wavelength range of the optical signal at the other spot to be measured.

The above mentioned specific embodiment is only one exemplifying case of the invention, and the description is relatively detailed and elaborate, but it should not be understood as a limitation on the patent protection scope of the invention. The order of detailed embodiment steps and model parameters can be adjusted correspondingly in light of the actual requirements. It must be noted that, the average technicians of the field, under the prerequisite of not departing from the conception of the invention herein, can make several transformations and improvements, all these shall belong to the protection scope of the invention.

1. An optical signal-to-noise ration measuring method, comprising the following steps:
measuring spectrum to be measured of measured optical signal at spot to be measured on optical transmission line, wherein the spectrum to be measured includes spectrum power density distribution of the measured optical signal in the channel wavelength range B;
obtaining spectrum to be compared, which includes spectrum power density distribution of the measured optical signal or signal with same spectrum feature as that of the measured optical signal, under SNR different from that of the spot to be measured in the channel wavelength range B;
in the channel wavelength range B, integrating the spectrum to be measured and the spectrum to be compared, respectively, to obtain total powers of the spectrum to be measured and the spectrum to be compared; and
according to integral power relationship and OSNR relationship between optical signal parts of the spectrum to be measured and the spectrum to be compared, using the obtained total powers of the spectrum to be measured and the spectrum to be compared to estimate the OSNR at the spot to be measured.

2. An in-band OSNR measuring method for measuring OSNR at the spot to be measured on the optical transmission line, including following steps:
step 1, measuring spectrum to be measured of measured optical signal at spot to be measured, wherein the spectrum to be measured includes spectrum power density distribution of the measured optical signal in the channel wavelength range B;
step 2, obtaining spectrum to be compared, which includes spectrum power density distribution of the measured optical signal or signal with same spectrum feature as that of the measured optical signal, under SNR different from that of the spot to be measured in the channel wavelength range B;
step 3, in the channel wavelength range B, integrating the spectrum to be measured and the spectrum to be compared respectively, to obtain the total powers of the spectrum to be measured and the spectrum to be compared respectively, wherein the total power P_{spectrum to be measured} of the spectrum to be measured includes integral power S _{spectrum to be measured} of optical signal and the integral power N_{spectrum to be measured} of noise signal, in the spectrum to be measured, and the total power P_{spectrum to be compared} of the spectrum to be compared includes the integral power S_{spectrum to be compared} of optical signal and the integral power N_{spectrum to be compared} of noise signal, in the spectrum to be compared;
Step 4, acquiring noise figure F and signal scale factor A, wherein the noise figure F is defined as:
$$F = \frac{{S}_{spectrum to be measured} / {N}_{spectrum to be measured}}{{S}_{spectrum to be compared} / {N}_{spectrum to be compared}} ,$$
wherein the signal scale factor A is defined as:
$$A = \frac{{S}_{spectrum to be compared}}{{S}_{spectrum to be measured}} ,$$
Step 5, according to the total powers P_{spectrum to be measured} and P_{spectrum to be compared} of the spectrum to be measured and the spectrum to be compared, as well as noise figure F and signal scale factor A, computing noise power N_{spectrum to be measured} of the spectrum to be measured in the channel wavelength range B, subtracting the noise power N_{spectrum to be measured} of the spectrum to be measured from the total power P_{spectrum to be measured} of the spectrum to be measured, then dividing by noise power
$${N}_{spectrum to be measured} \cdot \frac{{B}_{r}}{B}$$
in the integral bandwidth Bᵣ, to calculate OSNR of the measured optical signal at the spot to be measured.

3. The in-band OSNR measuring method in claim 2, wherein in the step 5, by using noise calculating equation as follows:
$${N}_{spectrum to be measured} = \frac{1}{( 1 - F )} ( {P}_{spectrum to be measured} - \frac{{P}_{spectrum to be compared}}{A} ) ,$$
the noise power N_{spectrum to be measured} of the spectrum to be measured is calculated.

4. The in-band OSNR measuring method in claim 3, wherein in the step 5, by using the following equation:
$$OSNR = 10 {log}_{10} ( \frac{{P}_{spectrum to be measured} - {N}_{spectrum to be measured}}{{N}_{spectrum to be measured} \cdot \frac{{B}_{r}}{B}} ) ,$$
OSNR of the measured optical signal at the spot to be measured is calculated, wherein Bᵣ stands for the integral bandwidth of noise signal and B stands for the channel wavelength range, i.e., the channel bandwidth.

5. The in-band OSNR measuring method in claim 3, wherein,
if the OSNR of the spectrum to be compared in the channel wavelength range B is known, the noise index F is expressed as:
$$F = ( {P}_{spectrum to be measured} - {N}_{spectrum to be measured} ) / ( {N}_{spectrum to be measured} \cdot {OSNR}_{spectrum to be compared} ) ,$$
wherein OSNR_{spectrum to be compared} stands for the OSNR of the spectrum to be compared, and the following equation is used:
$${N}_{spectrum to be measured} = \frac{1}{( 1 - \frac{( {P}_{spectrum to be measured} - {N}_{spectrum to be measured} )}{( {N}_{spectrum to be measured} \cdot {OSNR}_{spectrum to be comparted} )} )} ( {P}_{spectrum to measured} - \frac{{P}_{spectrum to be compared}}{A} ) ,$$
to calculate the noise power N_{spectrum to be measured} of the spectrum to be measured.

6. The in-band OSNR measuring method in claim 3, wherein,
if the OSNR of the spectrum to be compared in the channel wavelength range B is unknown, and OSNR of the spectrum to be compared is greatly larger than OSNR of the spectrum to be measured, the following equation is used:
$${N}_{spectrum to be measured} = {P}_{spectrum to measured} - \frac{{P}_{spectrum to be compared}}{A} ,$$
to calculate the noise power N_{spectrum to be measured} of the spectrum to be measured.

7. The in-band OSNR measuring method in claim 3, wherein,
if the OSNR of the spectrum to be compared in the channel wavelength range B is unknown, and OSNR of the spectrum to be compared is greatly smaller than OSNR of the spectrum to be measured, the following steps are used to get the noise index F:
in the channel wavelength range, by getting first integral bandwidth BW1 at the signal peak wavelength, integral powers
$${P}_{BW 1}^{spectrum to be measured} and {P}_{BW 1}^{spectrum to be compared}$$
of the spectrum to be measured and the spectrum to be compared at the first integral bandwidth BW1 are calculated respectively, by getting second integral bandwidth BW2 at spot shifting a certain distance towards shortwave from signal peak value, integral powers
$${P}_{BW 2}^{spectrum to be measured} and {P}_{BW 2}^{spectrum to be compared}$$
of the spectrum to be measured and the spectrum to be compared at the second integral bandwidth BW2 are calculated respectively, based thereon, first scale factor
$$k 1 = {P}_{BW 1}^{spectrum to be measured} / {P}_{BW 2}^{spectrum to be measured} ,$$
and second scale factor
$$k 2 = {P}_{BW 1}^{spectrum to be compared} / {P}_{BW 2}^{spectrum to be compared}$$
are calculated;
estimated value N_{BW1}^{spectrum to be compared} of integral power of noise signal of the spectrum to be compared in the first integral bandwidth BW1 is get, and the third scale factor is calculated as:
$$k 3 = ( {P}_{BW 1}^{spectrum to be compared} - {N}_{BW 1}^{spectrum to be compared} ) / {N}_{BW 1}^{spectrum to be compared} ;$$
by using the equation
F=k2·(BW1−BW2·k1)/(BW1·k1−BW2·k1·k2+BW1·k1·k3−BW1·k2·k3),
noise figure F is calculated.

8. The in-band OSNR measuring method in claim 7, wherein steps for getting the estimated value N_{BW1}^{spectrum to be compared} of integral power of noise signal of the spectrum to be compared in the first integral bandwidth BW1 comprises:
by getting third integral bandwidth BW3 in the area where signal takes relatively larger proportion of the spectrum to be compared relative to noise, and initially assuming the noise powers of the spectrum to be measured and the spectrum to be compared within the third integral bandwidth BW3 to be both 0, the equation to calculate scale factor A being simplified as follows:
$$A = {P}_{BW 3}^{spectrum to be compared} / {P}_{BW 3}^{spectrum to be measured} ,$$
by getting fourth integral bandwidth BW4 in the area where signal takes relatively smaller proportion of the spectrum to be compared relative to noise and based on the scale factor A, calculating noise power
$${N}_{BW 4}^{spectrum to be compared} = {P}_{BW 4}^{spectrum to be compared} - A \cdot {P}_{BW 4}^{spectrum to be measured}$$
in the fourth integral bandwidth BW4 of the spectrum to be compared can be calculated, and based on the noise power in the fourth integral bandwidth BW4, estimating noise power in the third integral bandwidth BW3:
$${N}_{BW 3}^{spectrum to be compared} = {N}_{BW 4}^{spectrum to be compared} \cdot BW 3 / BW 4 ,$$
according to obtained N_{BW3}^{spectrum to be compared}, reestimating the signal scale factor A:
through iterative computations, getting convergent noise power N_{BW4}^{spectrum to be compared} of the spectrum to be compared in the fourth integral bandwidth BW4, wherein iterative equation is as follows:
$${N}_{BW 4}^{spectrum to be compared} ( the {i}^{th} iteration ) = {P}_{BW 4}^{spectrum to be compared} - A ( the {i}^{th} iteration ) \cdot {P}_{BW 2}^{spectrum to be measured} ,$$
wherein
$$A ( the {i}^{th} iteration ) = ( {P}_{BW 3}^{spectrum to be compared} - {N}_{BW 4}^{spectrum to be compared} ( the {( i \text{-} 1 )}^{th} iteration ) \cdot \frac{BW 3}{BW 4} ) / ( {P}_{BW 3}^{spectrum to be measured} )$$
calculating estimated value of integral power of noise signal of the spectrum to be compared in the first integral band BW1 being calculated by the noise power N_{BW4}^{spectrum to be compared} of the spectrum to be compared in the fourth integral bandwidth BW4 and equation of
$${N}_{BW 1}^{spectrum to be compared} = {N}_{BW 4}^{spectrum to be compared} \cdot BW 1 / BW 4.$$

9. The in-band OSNR measuring method in claim 8, wherein,
the first integral bandwidth BW1 is selected as range of 20 pm of signal peak wavelength,
the second integral bandwidth BW2 is selected as range of 20 pm of signal peak wavelength shifting 60 pm to shortwave,
the third integral bandwidth BW3 is selected as range of 20 pm of signal peak wavelength,
the fourth integral bandwidth BW4 is selected as range of 20 pm of signal peak wavelength shifting 60 pm to longwave or shortwave.

10. The in-band OSNR measuring method of claim 2, wherein before getting the spectrum to be measured and the spectrum to be compared, no signal modulation including polarization modulation is conducted on the measured optical signal.

11. An in-band OSNR measuring device, comprising an input end, an optical amplifying module, a spectrum measuring module, and a control and computing module, wherein,
the optical amplifying module comprises an optical splitter and an optical amplifier;
the spectrum measuring module comprises a optical switch, and a spectrum scanner;
the input end input measured optical signal into the optical splitter, which splits the inputted measured optical signal into two branches, one of which is directly outputted to the optical switch in the spectrum measuring module, and the other is outputted into the optical switch in the spectrum measuring module via the optical amplifier,
under control of the control and computing module, the optical switch selects one branch of optical signal from the inputted two branches of optical signal, and output it to the spectrum scanner,
under control of the control and computing modules, the spectrum scanner scans and measures the inputted optical signal.

12. The in-band OSNR measuring device in claim 11, wherein, the control and computing module control the spectrum measuring module to scan and measure the inputted optical signal, implement the in-band OSNR measuring method of claim 2 on inputted optical signal, in order to get the OSNR of the measured optical signal.

13. The in-band OSNR measuring method in claim 4, wherein,
if the OSNR of the spectrum to be compared in the channel wavelength range B is known, the noise index F is expressed as:
$$F = ( {P}_{spectrum to be measured} - {N}_{spectrum to be measured} ) / ( {N}_{spectrum to be measured} \cdot {OSNR}_{spectrum to be compared} ) ,$$
wherein OSNR_{spectrum to be compared} stands for the OSNR of the spectrum to be compared, and the following equation is used:
$${N}_{spectrum to be measured} = \frac{1}{( 1 - \frac{( {P}_{spectrum to be measured} - {N}_{spectrum to be measured} )}{( {N}_{spectrum to be measured} \cdot {OSNR}_{spectrum to be comparted} )} )} ( {P}_{spectrum to measured} - \frac{{P}_{spectrum to be compared}}{A} ) ,$$
to calculate the noise power N_{spectrum to be measured} of the spectrum to be measured.

14. The in-band OSNR measuring method in claim 4, wherein,
if the OSNR of the spectrum to be compared in the channel wavelength range B is unknown, and OSNR of the spectrum to be compared is greatly larger than OSNR of the spectrum to be measured, the following equation is used:
$${N}_{spectrum to be measured} = {P}_{spectrum to measured} - \frac{{P}_{spectrum to be compared}}{A} ,$$
to calculate the noise power N_{spectrum to be measured} of the spectrum to be measured.

15. The in-band OSNR measuring method in claim 4, wherein,
if the OSNR of the spectrum to be compared in the channel wavelength range B is unknown, and OSNR of the spectrum to be compared is greatly smaller than OSNR of the spectrum to be measured, the following steps are used to get the noise index F:
in the channel wavelength range, by getting first integral bandwidth BW1 at the signal peak wavelength, integral powers P_{BW1}^{spectrum to be measured} and P_{BW1}^{specrum to be compared} of the spectrum to be measured and the spectrum to be compared at the first integral bandwidth BW1 are calculated respectively, by getting second integral bandwidth BW2 at spot shifting a certain distance towards shortwave from signal peak value, integral powers
$${P}_{BW 2}^{spectrum to be measured} and {P}_{BW 2}^{spectrum to be compared}$$
of the spectrum to be measured and the spectrum to be compared at the second integral bandwidth BW2 are calculated respectively, based thereon, first scale factor
$$k 1 = {P}_{BW 1}^{spectrum to be measured} / {P}_{BW 2}^{spectrum to be measured} ,$$
and second scale factor
$$k 2 = {P}_{BW 1}^{spectrum to be compared} / {P}_{BW 2}^{spectrum to be compared}$$
are calculated;
estimated value N_{BW1}^{spectrum to be compared} of integral power of noise signal of the spectrum to be compared in the first integral bandwidth BW1 is get, and the third scale factor is calculated as:
$$k 3 = ( {P}_{BW 1}^{spectrum to be compared} - {N}_{BW 1}^{spectrum to be compared} ) / {N}_{BW 1}^{spectrum to be compared} ;$$
by using the equation
F=k2·(BW1−BW2·k1)/(BW1·k1−BW2·k1·k2+BW1·k1·k3−BW1·k2·k3),
noise figure F is calculated.

16. The in-band OSNR measuring method in claim 15, wherein steps for getting the estimated value N_{BW1}^{spectrum to be compared} of integral power of noise signal of the spectrum to be compared in the first integral bandwidth BW1 comprises:
by getting third integral bandwidth BW3 in the area where signal takes relatively larger proportion of the spectrum to be compared relative to noise, and initially assuming the noise powers of the spectrum to be measured and the spectrum to be compared within the third integral bandwidth BW3 to be both 0, the equation to calculate scale factor A being simplified as follows:
$$A = {P}_{BW 3}^{spectrum to be compared} / {P}_{BW 3}^{spectrum to be measured} ,$$
by getting fourth integral bandwidth BW4 in the area where signal takes relatively smaller proportion of the spectrum to be compared relative to noise and based on the scale factor A, calculating noise power
$${N}_{BW 4}^{spectrum to be compaed} = {P}_{BW 4}^{spectrum to be compared} - A \cdot {P}_{BW 4}^{spectrum to be measured}$$
in the fourth integral bandwidth BW4 of the spectrum to be compared can be calculated, and based on the noise power in the fourth integral bandwidth BW4, estimating noise power in the third integral bandwidth BW3:
$${N}_{BW 3}^{spectrum to be compared} = {N}_{BW 4}^{spectrum to be compared} \cdot BW 3 / BW 4 ,$$
according to obtained N_{BW3}^{spectrum to be compared}, reestimating the signal scale factor A:
$$A = ( {P}_{BW 3}^{spectrum to be compared} - {N}_{BW 3}^{spectrum to be compared} ) / ( {P}_{BW 3}^{spectrum to be measured} - {N}_{BW 3}^{spectrum to be measured} )$$
through iterative computations, getting convergent noise power N_{BW4}^{spectrum to be compared} of the spectrum to be compared in the fourth integral bandwidth BW4, wherein iterative equation is as follows:
$${N}_{BW 4}^{spectrum to be compared} ( the {i}^{th} iteration ) = {P}_{BW 4}^{spectrum to be compared} - A ( the {i}^{th} iteration ) \cdot {P}_{BW 2}^{spectrum to be measured} ,$$
wherein
$$A ( the {i}^{th} iteration ) = ( {P}_{BW 3}^{spectrum to be compared} - {N}_{BW 4}^{spectrum to be compared} ( the {( i \text{-} 1 )}^{th} iteration ) \cdot \frac{BW 3}{BW 4} ) / ( {P}_{BW 3}^{spectrum to be measured} )$$
calculating estimated value of integral power of noise signal of the spectrum to be compared in the first integral band BW1 being calculated by the noise power N_{BW4}^{spectrum to be compared} of the spectrum to be compared in the fourth integral bandwidth BW4 and equation of
$${N}_{BW 1}^{spectrum to be compared} = {N}_{BW 4}^{spectrum to be compared} \cdot BW 1 / BW 4.$$

17. The in-band OSNR measuring method in claim 16, wherein,
the first integral bandwidth BW1 is selected as range of 20 pm of signal peak wavelength,
the second integral bandwidth BW2 is selected as range of 20 pm of signal peak wavelength shifting 60 pm to shortwave,
the third integral bandwidth BW3 is selected as range of 20 pm of signal peak wavelength,
the fourth integral bandwidth BW4 is selected as range of 20 pm of signal peak wavelength shifting 60 pm to longwave or shortwave.
